(19) United States
(12) Patent Application Publication
(10) Pub. No.: US 2018/0215328 A1
(43) Pub. Date: Aug. 2, 2018

(54) TWIN SHEET BELLY PAN AND METHOD OF PRODUCTION

(71) Applicant: FORD GLOBAL TECHNOLOGIES, LLC, Dearborn, MI (US)

(72) Inventor: Thomas Alfred Sweder, Livonia, MI (US)

(21) Appl. No.: 15/420,131

(22) Filed: Jan. 31, 2017

(51) Int. Cl. B60R 13/08; B29C 51/10; B29C 65/02; B62D 35/02; B62D 29/04; B60R 21/34

(52) U.S. Cl. CPC B60R 13/0861; B29C 51/105; B29C 65/02; B29L 2009/00; B62D 29/04; B60R 21/34; B62D 35/02

(57) ABSTRACT

A belly pan includes a first sheet having at least one energy management feature and a second sheet having a smooth aerodynamic surface. The first sheet is bonded to the second sheet. The belly pan is produced utilizing a twin sheet vacuum forming process.

### TECHNICAL FIELD

This document relates generally to the motor vehicle equipment field and, more particularly, to a twin sheet belly pan that may be produced utilizing a twin sheet vacuum forming process.

### BACKGROUND

Today's motor vehicles typically incorporate a belly pan along the underside of the motor vehicle immediately below and behind the front fascia. Such a belly pan may incorporate at least one energy management feature to provide protection to a pedestrian in the event of a motor vehicle pedestrian accident. Thus, a belly pan typically includes various energy management shapes such as a plurality of piano keys, one or more honeycomb ribs, curved ribs, boxes and the like. Additionally, a belly pan should also provide a smooth outer surface for good aerodynamics and clean air flow to provide for enhanced fuel economy. These seemingly conflicting functionalities are efficiently and effectively provided by the new and improved twin sheet belly pan disclosed herein. Advantageously, that belly pan may be made inexpensively from relatively low-cost materials in a quick and efficient manner utilizing a twin sheet vacuum forming process.

### SUMMARY

In accordance with the purposes and benefits described herein, a new and improved twin sheet belly pan is provided. That belly pan comprises a first sheet including at least one energy management feature and a second sheet including a smooth aerodynamic surface wherein the first sheet is bonded to the second sheet.

The energy management feature may comprise a plurality of ribs. Each rib of the plurality of ribs may assume any number of different shapes. In one possible embodiment at least one rib of the plurality of ribs is curved. In another possible embodiment the energy management feature is a honeycomb rib. In yet another possible embodiment, the energy management feature is a plurality of piano key-shaped ribs.

The first sheet may have a first thickness T₁ and the second sheet may have a second thickness T₂ where T₁≠T₂. The first sheet may be made from a first material while the second sheet may be made from a second material wherein the first material differs from the second material. In addition, the first sheet and the second sheet may be connected at a heat bonding line so as to form an integral belly pan structure.

In accordance with an additional aspect, a method is provided of producing a belly pan. That method comprises utilizing a twin sheet vacuum forming process to make a belly pan having a first sheet including at least one energy management feature and a second sheet having a smooth aerodynamic surface wherein the first sheet is heat bonded to the second sheet.

The method may include the step of loading the first sheet and the second sheet into a twin sheet vacuum forming machine. Further, the method may include the step of simultaneously heating the first sheet and the second sheet to a forming temperature. In addition, the method may include the step of forming the energy management feature in the first sheet. Further, the method may include the step of forming the smooth aerodynamic surface in the second sheet.

Still further, the method may include simultaneously vacuum molding the energy management feature in the first sheet and the smooth aerodynamic surface in the second sheet. Further, the method may include the step of heat bonding the first sheet to the second sheet thereby forming a two-sheet or twin sheet belly pan of integral structure.

In the following description, there are shown and described several preferred embodiments of the belly pan as well as the related method of producing that belly pan. As it should be realized, the belly pan and the related production method are both capable of other, different embodiments and their several details are capable of modification in various, obvious aspects all without departing from the belly pan and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the belly pan and production method and together with the description serve to explain certain principles thereof.

FIG. 1 is an exploded plan view of the belly pan showing the first sheet and the second sheet that are bonded together to form an integral belly pan structure.

FIG. 2 is a partially cut-away perspective view of the integral twin sheet belly pan showing various energy management features including, for example, a plurality of box ribs and a plurality of honeycomb-type ribs.

FIG. 3 is a detailed cross-sectional view of the structure illustrated in FIG. 2.

FIGS. 4a-4e are various schematic cross-sectional views of box rib constructions that may be utilized for the belly pan.

FIGS. 5a-5d illustrate the twin sheet vacuum forming process utilized to make the belly pan illustrated in FIGS. 1-3.

FIG. 5a illustrates the loading of a first sheet and a second sheet into a twin sheet vacuum forming machine and the simultaneous heating of those sheets to a forming temperature.

FIGS. 5b and 5c illustrate the vacuum forming process whereby the energy management feature is formed in the first sheet and the smooth aerodynamic surface is formed in the second sheet.

FIG. 5d illustrates removal of the formed integral belly pan from the twin sheet vacuum forming machine.

Reference will now be made in detail to the present preferred embodiments of the belly pan, examples of which are illustrated in the accompanying drawing figures.

### DETAILED DESCRIPTION

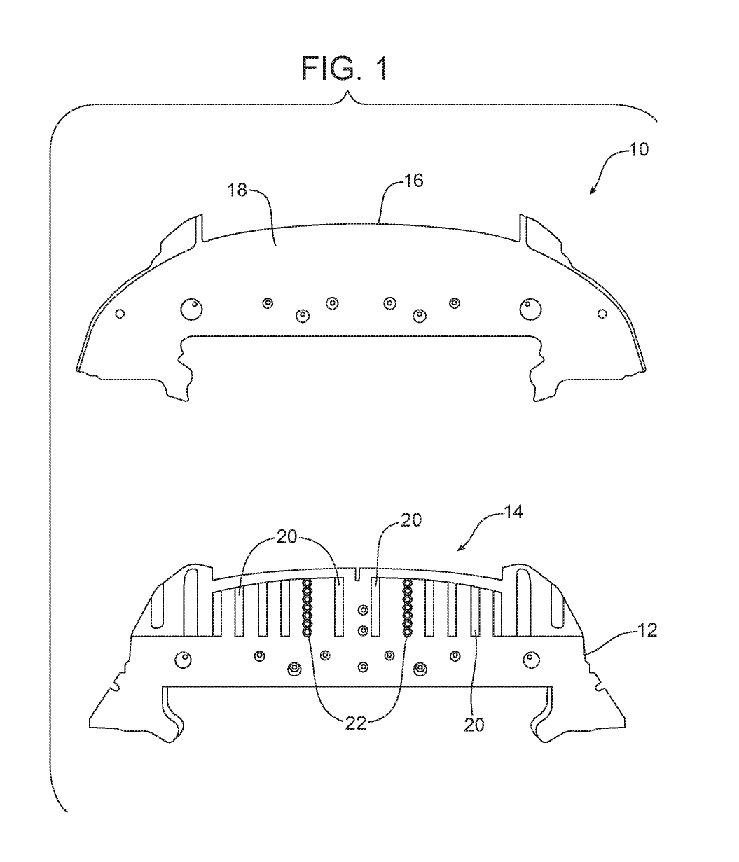

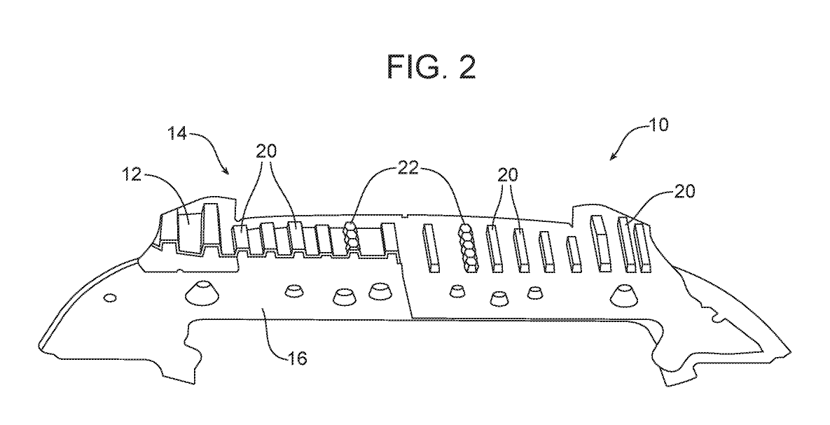

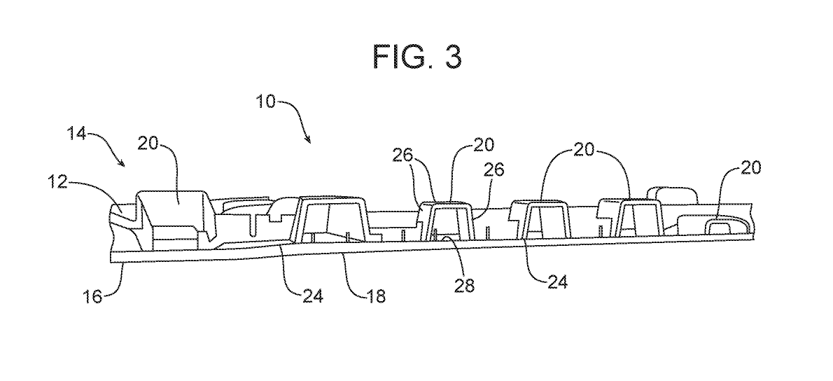

Reference is now made to FIGS. 1-3 illustrating the new and improved belly pan 10. The belly pan 10 includes a first sheet 12 having at least one energy management feature 14 for pedestrian protection in the event of a front-end pedestrian impact by a motor vehicle equipped with the belly pan. In addition, the belly pan 10 incorporates a second sheet 16 which includes a smooth aerodynamic surface 18. As best illustrated in FIGS. 2 and 3 the first sheet 12 is bonded to the second sheet 16 so as to form a “twin sheet” belly pan structure.

In the illustrated embodiment the energy management feature 14 provided in the first sheet 12 comprises a plurality of ribs. More specifically, the energy management feature 14 includes a plurality of box ribs 20 and a plurality of honeycomb ribs 22. The box ribs 20 and the honeycomb ribs 22 may be straight or curved. In some embodiments the energy management feature 14 may include both straight and curved box ribs 20 and straight and curved honeycomb ribs 22. In some embodiments the energy management feature 14 may only include box ribs 20 or only honeycomb ribs 22. In some embodiments including the illustrated embodiment, the box ribs 20 may have a “piano key” arrangement.

The first sheet 12 and the second sheet 16 may be made from any appropriate plastic or composite material suitable for forming in a twin sheet vacuum forming process and providing desired structural characteristics to the integral belly pan 10. For example, the first sheet 12 and the second sheet 16 may be made from filled or unfilled polypropylene. In some embodiments the first sheet 12 and the second sheet 16 are made from the same material. In other embodiments, the first sheet 12 and the second sheet 16 are made from different materials; meaning different plastics, different fillers, different plastic/filler composition ratios or the like.

Similarly in some embodiments, the first sheet 12 has a first thickness T₁ and the second sheet 16 has a second thickness T₂ where T₁≠T₂. In other embodiments, the first sheet 12 and the second sheet 16 are made from a material with the same thickness.

In the illustrated embodiment of the belly pan 10, the first sheet 12 and the second sheet 16 are connected at a heat bonding line 24 so as to form an integral belly pan structure. See FIG. 3.

As illustrated in FIG. 3, the box ribs 20 have a generally trapezoidal cross section with three sides 26 formed by the first sheet 12 and the fourth or lower side 28 formed by the second sheet 16.

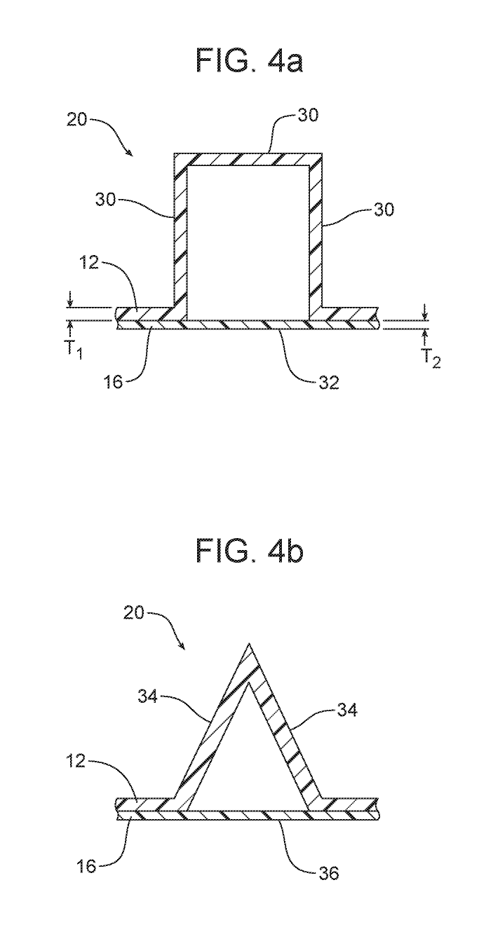

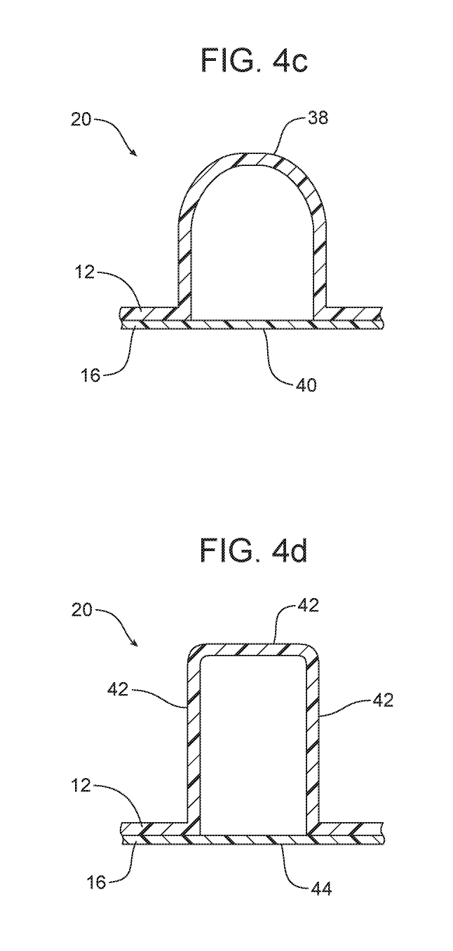

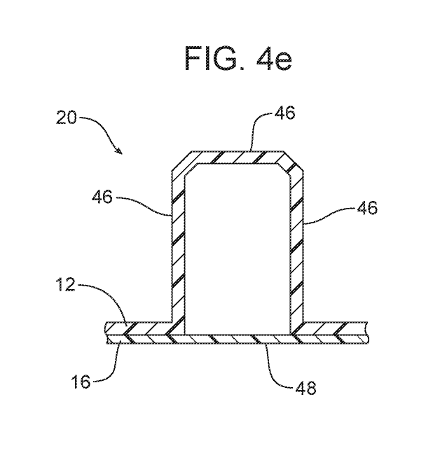

As illustrated in FIGS. 4a-4e, the box ribs 20 may assume a different cross-sectional shape. FIG. 4a illustrates a box rib 20 having an angular shape with three sides 30 formed by the first sheet 12 and the fourth or lower side 32 formed by the second sheet 16.

FIG. 4b illustrates yet another alternative shape for a box rib 20 including three sides: two sides 34 formed by the first sheet 12 and the third or lower side 36 formed by the second sheet 16.

FIG. 4c illustrates a box rib having a single curved or U-shaped side 38 formed by the first sheet 12 and the second or lower side 40 formed by the second sheet 16.

FIG. 4d illustrates a box rib 20 with a rectangular cross section having three sides 42 formed by the first sheet 12 and the fourth or lower side 44 formed by the second sheet 16.

FIG. 4e illustrates a box rib 20 having six sides including five sides 46 formed by the first sheet 12 and the sixth side 48 formed by the second sheet 16.

As should be appreciated, the plurality of ribs 20 of any particular belly pan 10 may assume any one or more than one of these shapes. Further, it should be appreciated that the shape, number of sides, length, height and width of each rib 20 not only affects the strength of the resulting belly pan 10 but also the acoustic properties of the belly pan. Generally, smaller box ribs 20 act as a sound chamber to trap certain higher sound frequencies while larger box ribs act as a sound chamber to trap certain lower frequencies.

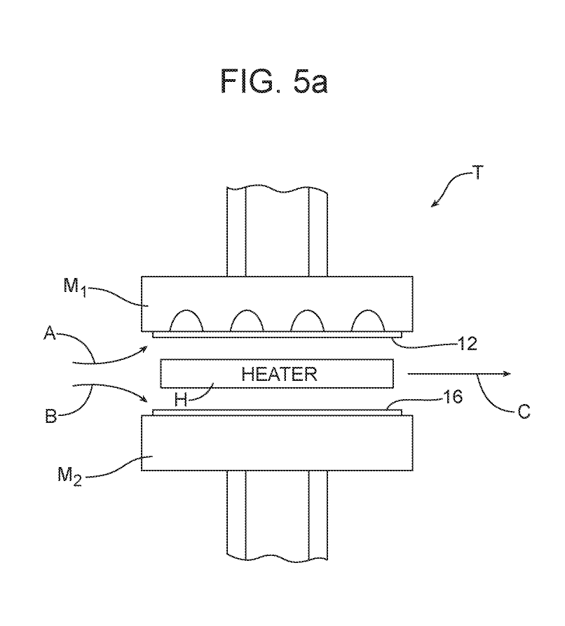

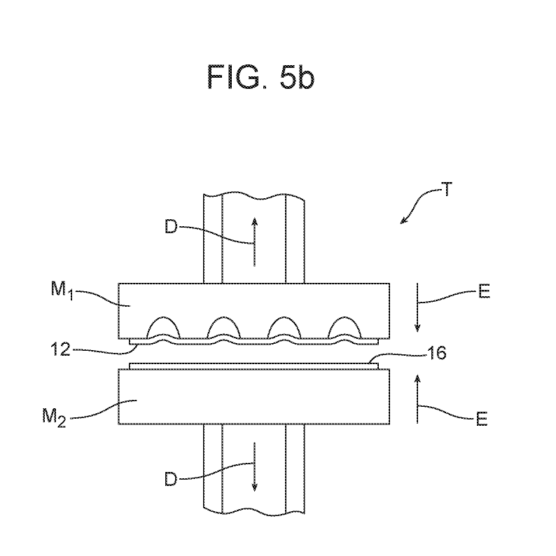

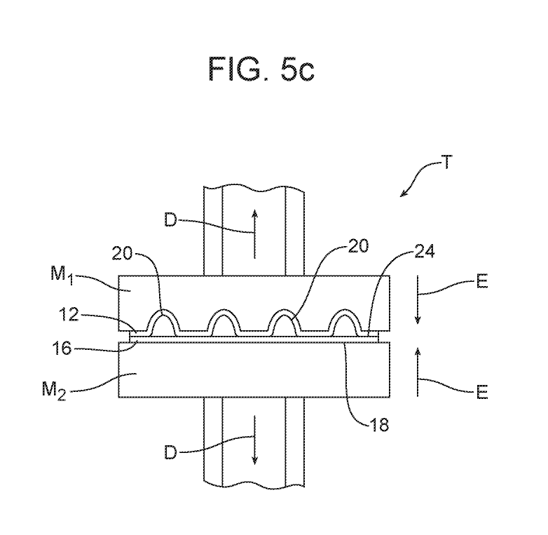

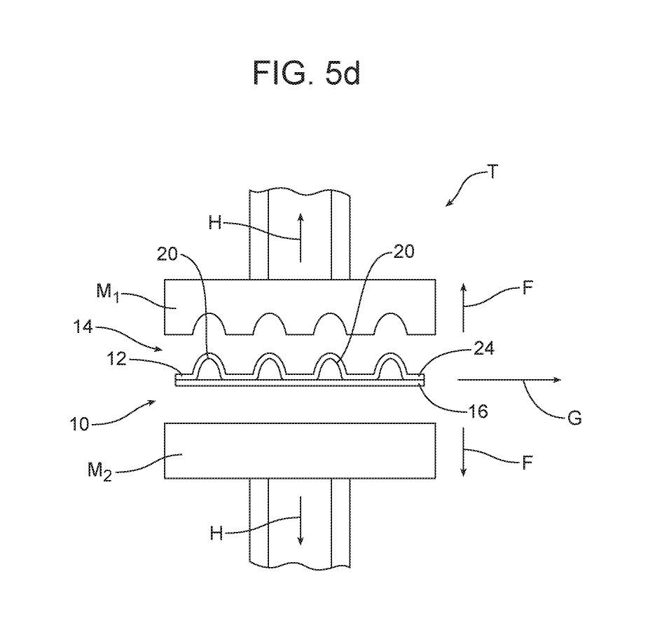

Reference is now made to FIGS. 5a-5d illustrating a method of producing the belly pan 10 utilizing a twin sheet vacuum forming process. As illustrated in FIG. 5a, the method includes loading the first sheet 12 and the second sheet 16 into the twin sheet vacuum forming machine T.

More specifically, as illustrated in FIG. 5a, the first sheet 12 is loaded into the first mold M₁ while the second sheet 16 is loaded into the second mold M₂. Note action arrows A and B. Next a heater H is inserted between the first sheet 12 and the second sheet 16 held, respectively in first mold M₁ and the second mold M₂. The first sheet 12 and the second sheet 16 are then simultaneously heated to a forming temperature. The heater H is then removed from between the molds M₁, M₂ (note action arrow C in FIG. 5a). A vacuum is drawn from the two molds M₁, M₂ (note action arrows D) and the two molds are closed together (note action arrows E).

The first sheet 12 and the second sheet 16 are softened sufficiently at the forming temperatures so as to be drawn by the force of the vacuum into the molds M₁, M₂ thereby forming the energy management feature 14 (note plurality of box ribs 20 illustrated in FIG. 5c in the first sheet formed by the first mold M₁) and the smooth aerodynamic surface 18 of the second sheet 16 formed by the second mold M₂. FIGS. 5b and 5c illustrate the simultaneous vacuum molding of the energy management feature 14 in the first sheet 12 and the smooth aerodynamic surface 18 in the second sheet 16. FIG. 5c also illustrates the heat bonding of the first sheet 12 to the second sheet 16 at the heat bonding line 24 thereby forming the two sheet or twin sheet belly pan of integral structure. FIG. 5d illustrates the opening of the molds M₁, M₂ (note action arrows F) and the removal of the integral twin sheet belly pan 10 from the twin sheet vacuum forming machine T (note action arrow G). Air may be forced through the molds M₁, M₂ (note action arrows H) in order to help eject the belly pan 10 from the molds M₁, M₂ of the twin sheet vacuum forming machine T.

In summary, the twin sheet vacuum forming process illustrated in FIGS. 5a-5d allows for simple and inexpensive production of the twin sheet belly pan 10. Advantageously, the first sheet 12 of the twin sheet belly pan 10 may be engineered without compromise to provide an energy management feature 14 that meets desired pedestrian protection parameters while the second sheet 16 may incorporate a smooth aerodynamic surface 18 to meet desired aerodynamic performance standards without compromise. The materials and thickness of those materials utilized to make the first sheet 12 and the second sheet 16 may also be selected without compromise to meet the functionality requirements of the belly pan 10. Advantageously, the resulting structure provides optimum performance from minimal weight materials.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A belly pan, comprising:
a first sheet including at least one energy management feature; and
a second sheet including a smooth aerodynamic surface wherein said first sheet is bonded to said second sheet.

2. The belly pan of claim 1, wherein said energy management feature is a plurality of ribs.

3. The belly pan of claim 2, wherein at least one rib of said plurality of ribs is curved.

4. The belly pan of claim 1, wherein said energy management feature is a honeycomb rib.

5. The belly pan of claim 1, wherein said energy management feature is a plurality of piano key-shaped ribs.

6. The belly pan of claim 1, wherein said first sheet has a first thickness T₁ and said second sheet has a thickness of T₂ where T₁≠T₂.

7. The belly pan of claim 1, wherein said first sheet is made from a first material and said second sheet is made from a second material wherein said first material differs from said second material.

8. The belly pan of claim 1, wherein said first sheet and said second sheet are connected at a heat bonding line so as to form an integral belly pan structure.

9. A method of producing a belly pan, comprising:
utilizing a twin sheet vacuum forming process to make the belly pan having a first sheet including at least one energy management feature and a second sheet having a smooth aerodynamic surface wherein said first sheet is heat bonded to said second sheet.

10. The method of claim 9, including loading said first sheet and said second sheet into a twin sheet vacuum forming machine.

11. The method of claim 10, including simultaneously heating said first sheet and said second sheet to a forming temperature.

12. The method of claim 11, including forming said energy management feature in said first sheet.

13. The method of claim 12, including forming said smooth aerodynamic surface in said second sheet.

14. The method of claim 10, including simultaneously vacuum molding said energy management feature in said first sheet and said smooth aerodynamic surface in said second sheet.

15. The method of claim 14, including heat bonding said first sheet to said second sheet thereby forming a twin sheet belly pan of integral structure.
